(19) United States
(12) Patent Application Publication
(10) Pub. No.: US 2024/0407066 A1
(43) Pub. Date: Dec. 5, 2024

(54) Device for Detecting the Angle and Intensity of Sunlight Exposure, An Indoor Dimming System, and A Method Thereof

(71) Applicant: LINGGUANG LIGHTING TECHNOLOGY(SHANGHAI)CO.,LTD, Shanghai (CN)

(72) Inventor: Jianhua Su, Shanghai (CN)

(21) Appl. No.: 18/203,225

(22) Filed: May 30, 2023

(51) Int. Cl. H05B 47/11; G01J 1/44; H05B 47/19

(52) U.S. Cl. CPC H05B 47/11; G01J 1/44; H05B 47/19; G01J 2001/4266

(57) ABSTRACT

Device for detecting the angle and intensity of sunlight exposure, an indoor dimming system, and a method thereof, The device for detecting the angle and intensity of sunlight exposure includes the following: Front cover, rear cover, sealing ring, first mounting plate, second mounting plate, and at least five photosensitive elements, The photosensitive elements are installed on the front of the front cover and four adjacent sides, There is a PCB board in the front cover, the PCB board is equipped with detection circuits connected to various photosensitive components, The sealing ring is installed between the front cover and the rear cover, The first mounting plate is fixed on the rear cover, The second installation plate is fixed on the carrier, The indoor dimming system includes a Bluetooth remote control, lighting fixtures, and a device for detecting the angle and intensity of sunlight exposure, The indoor dimming system method includes installing a device for detecting the angle and intensity of sunlight exposure; Obtain the voltage generated per unit area of each photosensitive element; Calculate the solar elevation angle, solar tilt angle and solar intensity at regular intervals; Fine tune the brightness of the lamp within the determined dimming range.

### TECHNOLOGY

The present invention relates to the field of lighting, This mainly relates to a device for detecting the angle and intensity of sunlight exposure, an indoor dimming system, and a method.

### BACKGROUND TECHNOLOGY

With the development of society, energy conservation in lighting has gradually become a consensus among people, in addition to using high-efficiency light sources, without affecting people's lighting needs, reasonably controlling the output intensity of the light source is also an important means of energy-saving lighting. Sunlight is the most suitable light source for the human visual system, reasonably utilize natural light in indoor lighting, not only can it protect human vision, but it can also reduce electricity consumption, it has broad development prospects and good economic and social value.

The impact of sunlight on the brightness of the interior mainly depends on the height angle, tilt angle, and light intensity of the sunlight. Therefore, detection of the height angle, tilt angle, and light intensity of the sun have extremely important significance for the application of sunlight in the field of energy-saving lighting.

### SUMMARY OF THE INVENTION

The present invention provides a device for detecting the angle and intensity of sunlight exposure, an indoor dimming system, and a method to address the above issues.

The technical solution adopted by the present invention to solve its technical problems is: A device for detecting the intensity of solar incidence angle includes a front cover, a back cover, a sealing ring, a first mounting plate, a second mounting plate, and at least five photosensitive components. The photosensitive components described above are set on the front of the front cover and four sides adjacent to the front, and the PCB plate described above is set in the front cover, which is equipped with detection circuits connected to each photosensitive component. The front cover and the back cover are fixed, the sealing ring described above is set between the front cover and the back cover, the first mounting plate described above is fixedly set on the back cover, the second mounting plate is fixedly set on the carrier of the solar incidence angle detection device, and the first mounting plate is fixed on the second mounting plate.

The photosensitive components installed on the front of the front cover and four sides adjacent to the front can convert sunlight into voltage signals, and obtain solar altitude angle, angle of inclination and intensity by processing voltage signals, providing data basis for indoor dimming.

As a preferred solution of the above scheme, the front cover described above is in a quadrangular frustum shape, which is a combination of a quadrangular prism and a quadrangular frustum. The first end of the quadrangular prism is fixed to the back cover, the second end of the quadrangular prism is connected to the larger bottom surface of the quadrangular frustum, the PCB plate described above is set in the quadrangular prism, and the sensor is set on the smaller bottom and side surface of the quadrangular pyramid.

As a preferred solution of the above scheme, the photosensitive component described above comprises a photoresistor, a photodiode, a phototriode or a photocell.

As a preferred solution of the above scheme, the detection circuit described above includes a single-chip microcomputer for collecting the voltage generated by various sensors, a first Bluetooth module connected to the single-chip microcomputer, and a first power module for power supply.

As a preferred solution of the above scheme, the first mounting plate described above is equipped with a first limit gear edge, the second mounting plate is equipped with a chute, and the first limit gear edge described above is set in the chute.

The present invention also provides an indoor dimming system, and the device for detecting the intensity of solar incidence angle described above is adopted, including a Bluetooth remote control and a lamp controlled by the Bluetooth remote control. The Bluetooth remote control and the solar incidence angle detection device are connected to each other.

As a preferred solution of the above scheme, the Bluetooth remote control described above includes a second Bluetooth module in intercommunication with the first Bluetooth module, a processor that calculates the voltage of various sensors collected on the device for detecting the intensity of solar incidence angle to obtain the solar incidence angle and intensity, a photosensitive probe that detects indoor illumination, and a second power module for power supply.

The present invention also provides an indoor dimming method, adopting one of the indoor dimming systems mentioned above, this includes the following steps:
S1: Install a device for detecting the angle and intensity of sunlight exposure, make the four sides of the sunlight angle intensity detection device, do not face due east, south, west, and north, with the top facing directly above;
S2: The sunlight irradiation angle intensity detection device obtains the voltage generated by the photosensitive components on each surface, if there are multiple photosensitive elements on a single surface, take the average value, the voltage generated per unit area of photosensitive elements facing east, south, west, north, and above is denoted as [symbol] [symbol] [symbol] Vₙ and Vᵤ;
S3: The Bluetooth remote control obtains [symbol] [symbol] [symbol] Vₙ and Vᵤ; The solar elevation angle θ₁, solar tilt angle θ₂ and solar intensity are calculatedl;
S4: According to the calculated solar elevation angleθ₁, solar tilt angle θ₂ and solar intensityl, And determine the dimming range of the lamp;
S5: Based on the illumination feedback from the photosensitive probe, the Bluetooth remote control, fine tune the brightness of the lamp within the determined dimming range.

The degree to which sunlight affects different locations in a room varies, under the same sunlight, the indoor brightness felt by people at different positions in the room also varies, therefore, after determining the approximate dimming range according to the solar elevation angle θ₁, solar tilt angle θ₂ and solar intensity l, also need to use the photosensitive probe on the Bluetooth remote control, Detect the specific illumination at its location and make fine adjustments, To achieve the most suitable illumination level for the location of the Bluetooth remote in control, and Bluetooth remote controls are usually located near people, therefore, adjusting the illumination of the location of the Bluetooth remote control is equivalent to adjusting the illumination of the person's location.

As a preferred solution for the above solution, when calculating solar elevation angle θ₁ and solar intensity l in step S3, The side corresponding to the larger voltage values in Vₛ and Vₙ, it is the sunrise side of the sunlight exposure angle intensity detection device, The calculation formulas of solar elevation angle θ₁ and solar intensity l are as follows:

$$\{ \begin{matrix}{V}_{1} = η \cdot l \cdot cos \vert 90 ° - ( α + γ ) \vert \\ {V}_{u} = η \cdot l \cdot sin α\end{matrix}$$

Among them, V₁ refers to the voltage generated by the side facing detection device for sunlight exposure angle intensity, taking the larger value of Vₛ and Vₙ,η is the light intensity voltage conversion efficiency of the photosensitive element,l is the intensity of the sun,α is the solar elevation angle,γ is the angle between the side and bottom of the sunlight exposure angle intensity detection device.

As a preferred solution for the above solution, when calculating the solar tilt angle θ₂ in step S3, Compare the values of [symbol] V_{w} and V₁,Set the tilt angle θ₂ of the sun at sunrise to 0°, The inclination angle θ₂ of the sun at sunset is 180°, When Vₑ is greater than V₁,Solar tilt angleθ₂∈(0°, 45°), When Vₑ is greater than or equal to V₁, Solar tilt angleθ₂∈(45°, 90°), When V_{w} is greater than or equal to V₁, Solar tilt angle θ₂∈(90°, 135°), When V_{w} is greater than V₁,Solar tilt angle θ₂∈(135°, 180°).

The advantages of the present invention are: it is possible to detect the solar altitude angle, angle of inclination and intensity, and adjust the light indoors according to this basis; The Bluetooth remote control is equipped with a photosensitive probe that can detect the illumination of its location to ensure that the illumination in its location, i.e. the person's location, is appropriate.

### ILLUSTRATED FIGURES

FIG. 1 is an exploded view of the detection device for sunlight irradiation angle intensity in the embodiment.

FIG. 2 is a schematic diagram of the three-dimensional structure of the first mounting plate in the embodiment.

FIG. 3 is a schematic diagram of a detection circuit in the embodiment.

FIG. 4 shows another circuit schematic diagram of the detection circuit in the embodiment.

FIG. 5 shows the circuit schematic diagram of the Bluetooth remote control in the embodiment.

FIG. 6 is a flowchart of the indoor dimming method in the embodiment.
1. Front cover 2. Sealing ring 3. Back cover 4. First mounting plate 5. Second mounting plate 6. photosensitive component 21. Through-hole 31. Fixed column 32. Clip 41. First screw hole 42. First limit gear edge 43. Vertical plate 51. Second limit gear edge 52. Chute 53. Second screw hole.

### EMBODIMENT

Below, through embodiments, and combined with the attached drawings, further explanation of the technical solution of the present invention.

### EXAMPLE

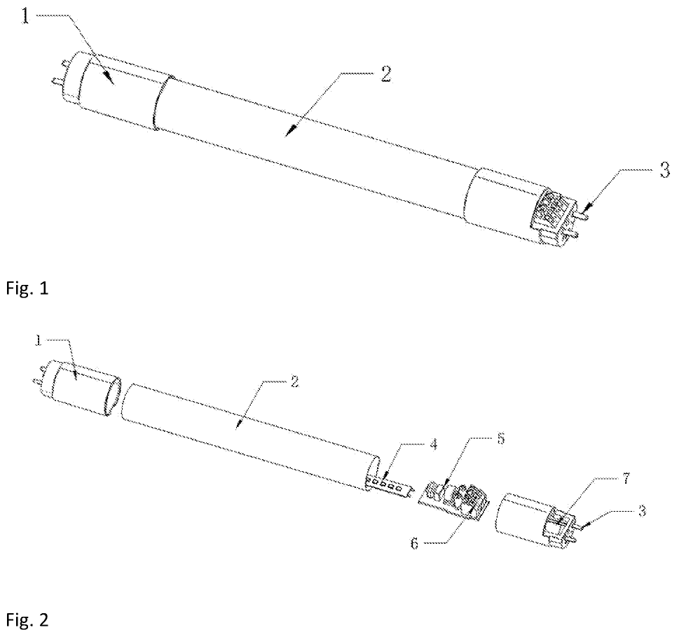

This embodiment is a device for detecting the intensity of solar incidence angle, which is shown in FIGS. 1 and 2: including a front cover 1, a back cover 3, a sealing ring 2, a first mounting plate 4, a second mounting plate 5, and at least five photosensitive component 6. The photosensitive component 6 described above are set on the front of the front cover 1 and four sides adjacent to the front, and the PCB plate described above is set in the front cover 1, which is equipped with detection circuits connected to each photosensitive component. The front cover 1 and the back cover 3 are fixed, the sealing ring 2 described above is set between the front cover 1 and the back cover 3, the first mounting plate 4 described above is fixedly set on the back cover 3, the second mounting plate 5 is fixedly set on the carrier of the solar incidence angle detection device, and the first mounting plate 4 is fixed on the second mounting plate 5.

In this embodiment, the front cover 1 is a combination of a quadrangular prism and a quadrangular frustum. The first end of the quadrangular prism is fixed to the back cover 3, the second end of the quadrangular prism is connected to the larger bottom surface of the quadrangular frustum, the PCB plate is set in the quadrangular prism, and the photosensitive component 6 is set on the smaller bottom and side surface of the quadrangular pyramid.

The back cover 3 is a rectangular plate, equipped with two clips 32 on each side of the plate, and the through-hole 21 is set at the corresponding clip 32 on the sealing ring 2. When the back cover is installed on the front cover, the sealing ring 2 shall be set on the back cover, and each clip 32 shall pass through the through-hole 21 and be buckled with the inner wall of the front cover. The fixed column 31 is set on the back cover 3, and the threaded hole is set inside the fixed column, with the opening of the threaded hole located on the back of the back cover. When the first mounting plate is installed, the screw passes through the first screw hole and is screwed into the threaded hole of the fixed column 31, thereby securing the first mounting plate with the back cover.

A circle of vertical plates 43 is set on the first mounting plate, and the vertical plates are horizontally extended outward to reach the first limit baffle plate 42. Correspondingly, the chute 52 is set on the second second mounting plate 5, and the first limit baffle plate 42 can slide in the chute. At the same time, the second limit baffle plate 51 is set at one end of the chute 52, and the portion of the first limit baffle plate that enters the chute too much can be placed on the second limit baffle plate.

In this embodiment, the second limit baffle plate 5 is set on the top platform of the building, the balcony plane, or an unobstructed ground.

In this embodiment, the solar incidence angle detection device is placed horizontally upwards. At the same time, it is necessary to ensure that the four sides of the front cover face east, west, south, and north respectively, and record the corresponding the photosensitive components. When the solar incidence angle detection device 5 is installed, the screw passes through the second screw hole 53 of the second mounting plate 5 and is screwed into the carrier. Then, the first mounting plate, back cover, sealing ring, and front cover are combined together, and the self sliding chute of the first limit plate of the first mounting plate is far away from the end of the second limit plate and slides into the chute.

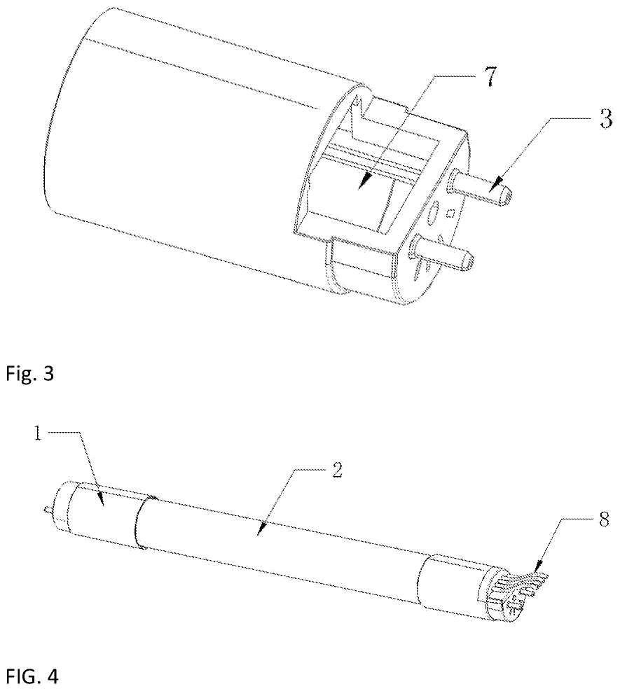

In this embodiment, the detection circuit includes a single-chip microcomputer for collecting the voltage generated by various sensors, a first Bluetooth module connected to the single-chip microcomputer, and a first power module for power supply. Photosensitive component is any of photoresistor, photodiode, phototriode or photocell. When photoresistor, photodiode or phototriode are used as photosensitive components, it is possible to set photocell in the detection circuit. Taking a phototriode as an example, the detection circuit is shown in FIG. 3. The first power module includes a parallel battery BT1, a charging circuit, and a photocell, which respectively power the first Bluetooth module and the single-chip microcomputer. The positive output end of the first power module is respectively connected to the base electrode of each phototriode, and the emitter electrode of the phototriode is respectively connected to the AD interface on the single-chip microcomputer.

When the photocell is a photosensitive component, the detection circuit is shown in FIG. 4. In the detection circuit, the photocell is used as a power module and also as a photosensitive component.

In this embodiment, TP4056 is a charging chip used in the charging circuit. Technicians in this field can choose single-chip microcomputer chips and Bluetooth chips based on actual situations. For example, STM32412 KB, STM32F030K, HC32F036, and JZ8M2626 can be used as single-chip microcomputer chips, and PHY6222 can be used as Bluetooth chips.

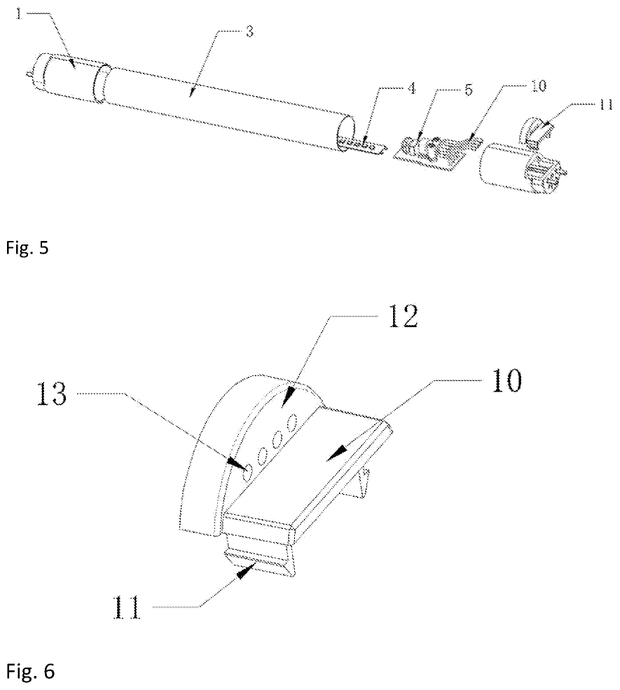

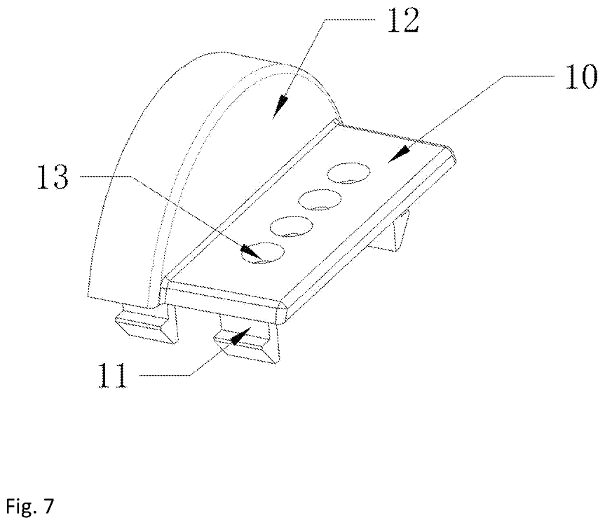

Correspondingly, in this embodiment, an indoor dimming system is provided, and the device for detecting the intensity of solar incidence angle described above is adopted, including a Bluetooth remote control and a lamp controlled by the Bluetooth remote control. The Bluetooth remote control and the solar incidence angle detection device are connected to each other. As shown in FIG. 5, the Bluetooth remote control includes a second Bluetooth module in intercommunication with the first Bluetooth module, a processor that calculates the voltage of various sensors collected on the device for detecting the intensity of solar incidence angle to obtain the solar incidence angle and intensity, a photosensitive probe for detecting indoor illumination, a second power module for power supply, buttons for controlling the lighting fixtures, and a display screen for displaying the brightness and status of the lighting fixtures.

Correspondingly, in this embodiment, an indoor dimming method is provided, and the above indoor dimming system is adopted, which is shown in FIG. 6: It includes the following steps:
S1: The device for detecting the intensity of solar incidence angle is installed so that the four sides of the device for detecting the intensity of solar incidence angle are facing east, south, west, and north respectively, and the top surface is facing directly above;
S2: The device for detecting the intensity of solar incidence angle described above can obtain the voltage generated by the photosensitive components on each surface. If multiple photosensitive components are set on the single surface, the average value is taken, and the voltage generated by the unit area of photosensitive components on the faces facing east, south, west, north, and above is marked as Ve, Vs, Vw, Vn, and Vu, respectively;
S3: The Bluetooth remote controller described above can acquire Vₑ, Vₛ, V_{w}, Vₙ and Vᵤ every other period of time, and calculate the solar altitude angle θ₁. solar inclination angle θ₂ and solar intensity l; When solar altitude angle θ₁ and solar intensity l are calculated, the side corresponding to the higher voltage values in Vₛ and Vₙ is the sunrise side of the device for detecting the intensity of solar incidence angle, and the calculation formula of solar altitude angle θ₁ and solar intensity l is as follows;

$$\{ \begin{matrix}{V}_{1} = η \cdot l \cdot cos \vert 90 ° - ( α + γ ) \vert \\ {V}_{u} = η \cdot l \cdot sin α\end{matrix}$$

Among them, Vₗ is the voltage generated by the side facing the device for detecting the intensity of solar incidence angle, and the larger value of Vₛ and Vₙ is taken, η is the conversion efficiency of the light intensity voltage of the photosensitive component, l is the solar intensity, α is the solar altitude angle, and γ is the included angle between the side and bottom of the device for detecting the intensity of solar incidence angle.

Compare the values of [symbol] V_{w} and V₁, Set the tilt angle θ₂ of the sun at sunrise to 0°, The inclination angle θ₂ of the sun at sunset is 180°, When Vₑ is greater than V₁,Solar tilt angleθ₂∈(0°, 45°), When Vₑ is greater than or equal to V₁, Solar tilt angleθ₂∈(45°, 90°), When V_{w} is greater than or equal to V₁, Solar tilt angleθ₂∈(90°, 135°), When V_{w} is greater than V₁,Solar tilt angleθ₂∈(135°, 180°).
S4: The Bluetooth remote controller described above can obtain the solar altitude angle, solar inclination angle and solar intensity according to the calculation, and determine the dimming range of the lamp; It is possible to obtain the dimming range by looking up the table in the preset dimming table. The items in the dimming table include solar inclination angle, solar altitude angle, solar intensity and dimming range.
S5: According to the illumination feedback from the photosensitive probe, the Bluetooth remote control described above can slightly adjust the brightness of the lamp within the determined dimming range. Bluetooth remote controls are used to control lighting fixtures, so they are usually placed near people, so it is possible to consider the location of the Bluetooth remote control as the location of the person. The degree to which sunlight affects different positions in a room varies. Under the same sunlight, people can experience different indoor brightness at different positions in the room. Therefore, after determining the approximate dimming range according to the solar altitude angle, solar inclination angle and solar intensity, it is necessary to detect the specific illumination of its location through the photosensitive probe on the Bluetooth remote controller and slightly adjust it, so as to make the illuminance at the location of the Bluetooth remote controller reach the most appropriate illuminance.

What is claimed is:

1. A device for detecting the intensity of solar incidence angle includes a front cover, a back cover, a sealing ring, a first mounting plate, a second mounting plate, and at least five photosensitive components. The photosensitive components described above are set on the front of the front cover and four sides adjacent to the front, and the PCB plate described above is set in the front cover, which is equipped with detection circuits connected to each photosensitive component. The front cover and the back cover are fixed, the sealing ring described above is set between the front cover and the back cover, the first mounting plate described above is fixedly set on the back cover, the second mounting plate is fixedly set on the carrier of the solar incidence angle detection device, and the first mounting plate is fixed on the second mounting plate.

2. A device for detecting the angle and intensity of sunlight exposure according to claim 1, Its characteristics are: the front cover described above is in a quadrangular frustum shape, which is a combination of a quadrangular prism and a quadrangular frustum. The first end of the quadrangular prism is fixed to the back cover, the second end of the quadrangular prism is connected to the larger bottom surface of the quadrangular frustum, the PCB plate described above is set in the quadrangular prism, and the sensor is set on the smaller bottom and side surface of the quadrangular pyramid.

3. A device for detecting the angle and intensity of sunlight exposure according to claim 1, Its characteristics are: the photosensitive component described above comprises a photoresistor, a photodiode, a phototriode or a photocell.

4. A device for detecting the angle and intensity of sunlight exposure according to claim 1, Its characteristics are: the detection circuit described above includes a single-chip microcomputer for collecting the voltage generated by various sensors, a first Bluetooth module connected to the single-chip microcomputer, and a first power module for power supply.

5. A device for detecting the angle and intensity of sunlight exposure according to claim 1, Its characteristics are: the first mounting plate described above is equipped with a first limit gear edge, the second mounting plate is equipped with a chute, and the first limit gear edge described above is set in the chute.

6. An indoor dimming system, The device for detecting the intensity of sunlight exposure angle according to any one of claims 1-5, Its characteristics are: including a Bluetooth remote control and a lamp controlled by the Bluetooth remote control. The Bluetooth remote control and the solar incidence angle detection device are connected to each other.

7. An indoor dimming system according to claim 6, Its characteristics are: the Bluetooth remote control described above includes a second Bluetooth module in intercommunication with the first Bluetooth module, a processor that calculates the voltage of various sensors collected on the device for detecting the intensity of solar incidence angle to obtain the solar incidence angle and intensity, a photosensitive probe that detects indoor illumination, and a second power module for power supply.

8. An indoor dimming method, Adopting the system described in any one of claims 6-7, Its characteristics are: This includes the following steps:
S1: Install a device for detecting the angle and intensity of sunlight exposure, Make the four sides of the sunlight angle intensity detection device, Do not face due east, south, west, and north, with the top facing directly above;
S2: The sunlight irradiation angle intensity detection device obtains the voltage generated by the photosensitive components on each surface, If there are multiple photosensitive elements on a single surface, take the average value, The voltage generated per unit area of photosensitive elements facing east, south, west, north, and above is denoted as [symbol] [symbol] [symbol] Vₙ and Vᵤ;
S3: The Bluetooth remote control obtains [symbol] [symbol] [symbol] Vₙ and Vᵤ; The solar elevation angleθ₁, solar tilt angleθ₂ and solar intensity are calculatedl;
S4: According to the calculated solar elevation angleθ₁, solar tilt angle θ₂and solar intensityl, And determine the dimming range of the lamp;
S5: Based on the illumination feedback from the photosensitive probe, the Bluetooth remote control, Fine tune the brightness of the lamp within the determined dimming range.

9. An indoor dimming method according to claim 8, Its characteristics are: When calculating solar elevation angleθ₁ and solar intensityl in step S3, The side corresponding to the larger voltage values in Vₛ and Vₙ, It is the sunrise side of the sunlight exposure angle intensity detection device, The calculation formulas of solar elevation angle θ₁and solar intensity l are as follows:
$$\{ \begin{matrix}{V}_{1} = η \cdot l \cdot cos \vert 90 ° - ( α + γ ) \vert \\ {V}_{u} = η \cdot l \cdot sin α\end{matrix}$$
Among them, V₁ refers to the voltage generated by the side facing detection device for sunlight exposure angle intensity, taking the larger value of Vₛ and Vₙ, is the light intensity voltage conversion efficiency of the photosensitive element,l is the intensity of the sun,α is the solar elevation angle,γ is the angle between the side and bottom of the sunlight exposure angle intensity detection device.

10. An indoor dimming method according to claim 9, Its characteristics are: When calculating the solar tilt angle θ₂ in step S3,Compare the values of [symbol] V_{w} and V₁,Set the tilt angle θ₂ of the sun at sunrise to 0°,The inclination angle θ₂ of the sun at sunset is 180°, When Vₑ is greater than V₁,Solar tilt angleθ₂∈(0°, 45°), When Vₑ is greater than or equal to V₁, Solar tilt angleθ₂∈(45°, 90°), When V_{w} is greater than or equal to V₁, Solar tilt angleθ₂∈(90°, 135°), When V_{w} is greater than V₁,Solar tilt angleθ₂∈(135°, 180°).
